(19) United States
(12) Patent Application Publication
(10) Pub. No.: US 2006/0087948 A1
(43) Pub. Date: Apr. 27, 2006

(54) Optimized medium with anisotropic dipole emission for fluorescent single or multilayer storage

(75) Inventors: Marcello Leonardo Mario Balistreri, Eindhoven (NL); Christopher Busch, Eindhoven (NL); Johannes Theodorus Adriaan Wilderbeek, Eindhoven (NL); Milan Saalmink, Eindhoven (NL); Wilma Van Es-Spiekman, Eindhoven (NL); Emiel Peeters, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklijke phillips electronics n.v.

(21) Appl. No.: 10/517,914

(22) PCT Filed: Jun. 13, 2003
(86) PCT No.: PCT/IB03/02870

§ 371 Date: Dec. 14, 2004

(30) Foreign Application Priority Data
Jun. 19, 2002 (EP) 02077425.3
Mar. 12, 2003 (EP) 03100621.6

(51) Int. Cl. G11B 7/00

(52) U.S. Cl. 369/100

(57) ABSTRACT

Optical data storage method, reading method, device (40) and storage medium (42,43), comprising storing data by modifying optical properties of polymer material (42), whereby writing is initiated by reorientation of photo-orientable units, typically by illuminating with light at a wavelength that initiates the reorientation, and whereby reading of data includes collection of anisotropic emission from dipole emitters.

The present invention relates to a method, device and storage medium for optical data storage.

There exist a number of optical storage techniques. One example of a technique is based on changing reflectivity of a storage layer when “writing” thereto. Systems based on this technique have an advantageous property in respect of that the collection efficiency of the objective lens, for a single-layer, always is 100% due to the fact that an outgoing light as a reflection of a coherent incoming light, also is coherent, which means that the light path for the incoming and outgoing light is reversible. However, this storage technique is typically not suitable for multi-layer recording in a stacked storage device because of ghost images, coherent cross talk as a result of coherent light, and poor transmission for each layer for both incident laser light and signal light. Yet another drawback is that a difference in index of refraction of written and non-written memory cells causes an optical beam to scatter as it transverses the different layers, resulting in a decreased beam quality.

Other techniques may involve the usage of fluorescent materials such as dyes etc. One is to use a fluorescent dye that is dissolved in a polymer matrix. In this case the index of refraction can be tuned to that of the substrates to avoid problems with scattering of the optical beams. Furthermore, the multi-layer storage mediums can be chosen such that they are transparent at the fluorescent signals wavelengths, effectively eliminating half the losses and disturbances associated with standard reflective technologies. By means of using fluorescent dyes, there are several possibilities to obtain a storage device. Irreversible storage of data such as Write Once Read Many (WORM) data storage is possible by photo bleaching of fluorescent material in a polymer matrix. The material is heated directly upon irradiation with a writing laser beam. Alternatively, quencher molecules are initially deposited in a layer above a layer containing the fluorescent material, comprising so-called “fluorophores”. When the material is heated by the laser beam the quencher molecules decompose and form radicals, which can diffuse to the fluorophores when the temperature exceeds a prior adjusted transition temperature of the polymer matrix, such as a glass transition temperature, and the melting and/or decomposition temperature of the quencher molecules. The chemical structure of the fluorophores, and hence the fluorescence spectrum and fluorescence efficiency is changed after the radicals have reacted with the fluorophores. The fluorescent signal emitted by reacted fluorophores is significantly different from the signal emitted by unreacted fluorophores upon irradiation with a “reading beam”. This feature is then used for reading stored data. However, this concept suffers from the disadvantage of a low data rate during writing due to slow diffusion of the radicals. Furthermore, the contrast obtained is poor because only a part of the illuminated dyes will be photo bleached resulting in a low data rate.

Another technique based on fluorescence is to co-dissolve the quencher molecules with the fluorophores in the polymer matrix. In this way, the radicals, which are formed upon heating, do not have to diffuse into the layer containing the fluorophores, but can directly react with them. This results in an increased contrast and thus an increased data rate; however, a drawback is that the stability of the non-written memory cells is significantly decreased.

As far as storage techniques that utilize fluorescence goes, the light path of the emitted light is not the reverse of the incident laser light path, hence the reversibility of the incident and emitted light path is not true. The optical characteristics of the emitted photons, such as their energy and phase, using such a technique are not the same as the optical characteristics of the incident photons. While this in fact has many advantages (see below) one disadvantage is that the light being emitted is emitted under a larger solid angle than that defined by the NA (numeric aperture) used by the incident light. Therefore a significant amount of signal intensity is lost during signal collection of emitted light. By simple geometrical considerations it can be shown that the collection efficiency for isotropic light emission ≈(NA/2n)², where NA is the numerical aperture for the incident light and n the refractive index of the substrate being used. For a NA of 0.6 and a refractive index of 1.62 of a polycarbonate substrate at a certain wavelength, this results in a collection efficiency of only 3.6%.

Moreover, from the patent application WO 02/47090, A1, is known a data storage method and device including materials that have three-dimensional optical storage capabilities, where said materials comprise a polymer matrix and nematic liquid crystal droplets as well as photosensitive material dispersed through the matrix. Storage of data is performed by illuminating zones of data storage material by coherent polarized infra-red light, whereby directors of illuminated material are aligned, causing alignment of photosensitive material. Reading of stored optical data comprises illumination of data storage material which has optical data stored therein, causing photosensitive material of zones of aligned directors of nematic liquid crystal droplets to emit fluorescence at a greater intensity compared to zones of non-aligned directors, and detecting fluorescence within the zones of aligned detectors.

This device and method of writing and reading has the property of being relatively complex and is therefore likely to become expensive for data storage applications. Another property of such a device and such a method is a relatively long switching time, of the order of 100 ms, which thus disables high data rates.

There is still a problem how to achieve a higher collection efficiency for light emission, leading to increased detected signal strength and data rate, in combination with a high writing speed, a good sensitivity during writing and a high stability of written and non-written storage areas.

Furthermore, problems including scattering, concerning stacking of storage layers to obtain large capacity have to be solved.

It is an object of the invention to provide a significant amount of anisotropic emission when reading data stored in a storage medium.

The invention also provides optical storage of data with a good sensitivity during writing and reading of said data.

According to an aspect of the invention, it has now been found that an especially beneficial form of optical data storage is provided by (re)orientation of aligned anisotropic molecules initiated by a very short light pulse, which aligned anisotropic molecules thereafter self-develop during a time period which is typically longer than the time period for the light pulse. Typically, this light is laser light. Preferably, the variation of orientation (or molecular order) is achieved by means of irradiation of light, especially by means of a laser beam. Generally, the method is performed in such a manner that the optical information is stored by means of a laser beam through a local reorientation or disorientation of molecular segments.

According to another aspect of the invention, there is provided a device for optical data storage using polymer material as storage medium, whereby the device comprises a film at least partly made of a polymer material in order to store data by means of local variation of the molecular order, or orientation, of a polymer comprising photo-orientable groups.

According to a preferred embodiment of the invention, there is provided a method for writing data in a storage medium comprising polymer material by modifying its optical properties, said method comprising the steps of:

heating up the material above the glass-transition temperature (T_{g}),

performing alignment of the material, and

initiating the writing by reorientation of photo-orientable-groups in the polymer material by means of illuminating with light at a wavelength and for a time period, or by other means, that initiates the reorientation, enabling anisotropic emission during reading of stored data.

According to another embodiment of the invention, there is provided a device for optical data storage, comprising:

polymer material as storage medium,

means for heating up the material above the glass-transition temperature (T_{g}),

means for performing alignment of said material, and

means for initiating the writing by orientation of photo-orientable units of the polymer by illuminating with light at a wavelength and for a time period, or by other means, that initiates the reorientation, whereby data can be stored in the device comprising polymer material by modifying its optical properties, enabling anisotropic emission during reading of stored data.

According to yet another embodiment of the invention, there is provided a storage medium comprising polymer material, adapted to store data by modifying its optical properties, said polymer material comprising photo-orientable groups, which can be reoriented upon illumination with light at a wave-length and for a time period that initiates the reorientation, which can self-develop at a suitable temperature, typically above the glass transition temperature (T_{g}).

According to still yet another embodiment of the present invention, there is provided a method to read data stored in an optical data storage device, that comprises polymer material as storage medium, means for heating up the material above the glass-transition temperature (T_{g}), means for performing alignment of the material, means for initiating the writing by reorientation of photo-orientable units of the polymer and dipole emitters that can be aligned, said method comprising the steps of:

illuminating with light at a wavelength, that causes the anisotropic fluorescent dipole emitters to emit light and,

collecting the anisotropic emission from said dipole emitters.

Besides the invention provides optical storing of data at high speed and provides high stability of stored information. Herein, the term “high speed” means not significantly slower than within nano-seconds, such as within 10-50 ns. Initiating writing is performed during a time period that is significantly shorter than a time scale on which the polymer, such as an LC polymer, reorients.

These and other aspects of the invention will be apparent from the embodiments(s) described hereinafter.

The present invention will also be more clearly understood from the following description of the preferred embodiments of the invention read in conjunction with the attached drawings, in which:

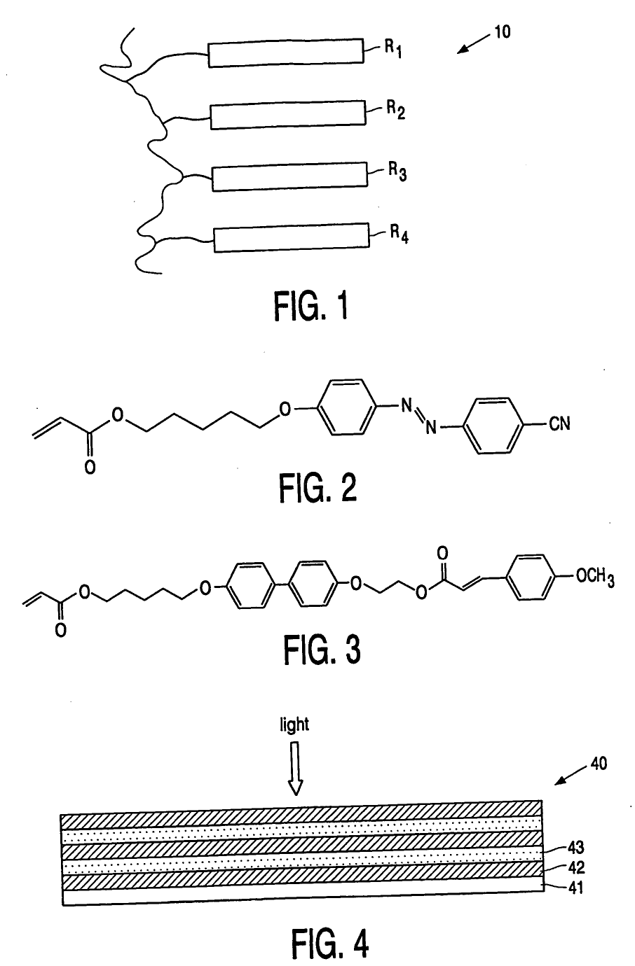

FIG. 1 illustrates a multifunctional polymer according to a preferred embodiment of the invention.

FIG. 2 illustrates a reactive monomer comprising an azo-benzene group.

FIG. 3 illustrates reactive monomer comprising a cinnamate group.

FIG. 4 illustrates a device for storing data having stacked storage layers.

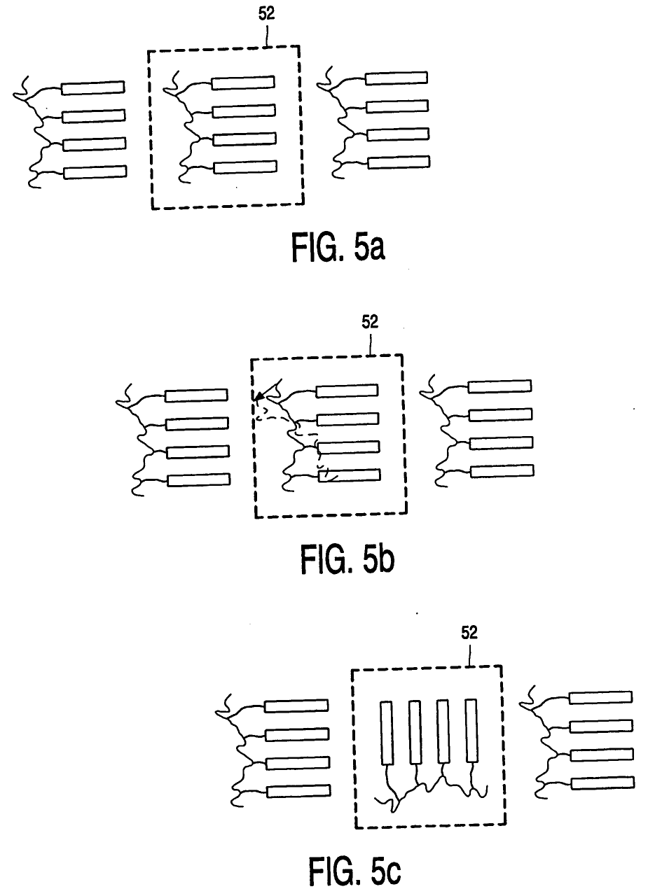

FIG. 5 illustrates how the polymer of FIG. 1 is converted from a non-written state to a written state.

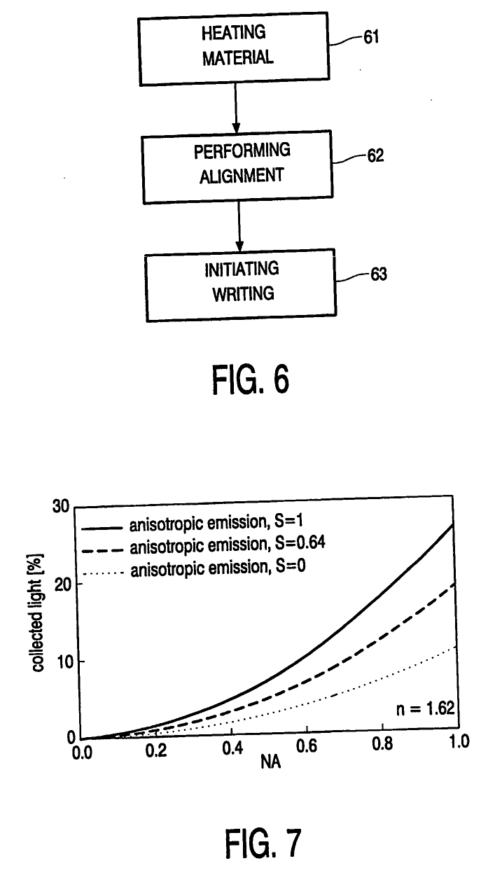

FIG. 6 is a flow-chart illustrating a preferred embodiment of the method of writing according to the invention.

FIG. 7 visualizes the collection efficiency of emitted light as a function of the numeric aperture of a objective lens, for three different degrees of order.

The invention will now be described starting with reference to FIG. 1 illustrating a multifunctional polymer according to a preferred embodiment of the invention.

The different properties that are required to store information are combined in the multi-functional polymer as illustrated in FIG. 1. The polymer 10 comprises three or more different functional groups. The first group R₁, induces liquid crystallinity, the second group R₂ is a photo-orientable group and the third group R₃ contains a fluorescent chromophore. Optionally a fourth group R₄ can possess an additional functionality, e.g. to tune the glass transition temperature T_{g} of the polymer, or incorporates a quencher functionality. In this way, it is possible to optimize and fine-tune different functions of separated groups independently. Of course, more functional groups can be added if required, without departing from the inventive idea.

It is also possible to use a polymer with less than three functional groups if different functionalities are combined in one group, e.g. a fluorescent moiety and a mesogenic group can be combined in a fluorescent liquid crystalline group. Other combinations are also possible. For instance, the function of the third group R₃ incorporated in the photo-orientable group, R₂.

Preferably, the polymer is provided with groups that provide the high stability of anisotropic polymers for data storage, but at the same time avoid problems with slow switching. The storage is based on a photo-induced change in suitable molecular groups, which can be provided into the main chain of the polymer or in side-groups.

The polymer described in FIG. 1 is only an example of a polymer with functional groups provided in the side-groups thereof, and other configurations that fulfill the requirements can also be employed.

The first group R₁ inducing liquid crystallinity can be provided in an essentially known manner, as for instance described in “Handbook of Liquid Crystal Research”, Peter J. Collings, Jay S. Patel (Eds.), Oxford University Press, New York, 1997, which will therefore not be described in more detail. As an example, the first group R₁ comprises repetitive units, including spacer units, and groups providing liquid crystal character such as mesogenic groups. The liquid crystalline units are typically provided in side-groups, but may also be present in the backbone of the polymer 10, or in both.

The second group R₂ comprises photosensitive units, that are capable to isomerize. The photosensitive units are typically provided in side-groups, but may also be present in the backbone of the polymer 10, or in both. Usually these photosensitive groups are based on one or more of the general formula
R—PH
where PH is a photosensitive group, preferably selected from the group comprising azobenzene, biazobenzene, triazobenzene and azoxybenzene, as well as alkyl substituted derivatives of the same, stilbene or spiropyran groups, and where R stands for a group which enables the chemical bonding of the photochemical unit into the polymer 10, typically a group that is capable of polymerization or polycondensation. For instance azo-benzene groups are rewritable. Upon irradiation with light of an appropriate wavelength, azo-benzene units will undergo a reversible cis-trans isomerization around the nitrogen-nitrogen double bond. In this process, there is a driving force for the azo-benzene units to decrease the absorption cross section and orient their absorption dipole moment along the propagation direction of the light. FIG. 2 illustrates a reactive monomer comprising an azo-benzene group.

It is also possible to use other groups than those that can form cis-trans isomers, which reversibly can change molecular order by irradiation with light, of which particular examples will not be discussed herein, since they are obvious for a person skilled in the art. It is also possible to provide irreversible writing by means of for instance cinnamate groups. Such a group undergoes upon irradiation with light of suitable wavelength a photo-addition reaction, which results in an orientation perpendicular to an E-vector of the light. Since this reaction is not reversible, the writing can be considered as an example of WORM-type of writing. FIG. 3 illustrates a reactive monomer comprising a cinnamate group.

Presently, there is a great demand for WORM optical data storage disks, so-called “CD-R” and this demand is expected to increase which the increase of the storage capacity of the optical data disks. When using a WORM medium for content distribution, the writing process could be serial (data bits are written one after the other); however, it is economically not interesting to incorporate serial writing processes in the manufacturing process of cheap optical data storage media. Data replication during manufacturing is typically only worth-while when it can be done in a parallel writing process, e.g. via a stamper or a mould. This is one of the essential advantages of optical storage over other storage options such as hard disk and solid state memories. Therefore, in a ROM medium, it is preferred to use some type of parallel writing, even if this is not disclosed herein.

In FIG. 1, the third group R₃ comprising an emitter having a dipole moment is positioned adjacent to the photo-orientable group R₂. As the storage material is illuminated with light having a certain wavelength and during a period of time, (as described above) the comprised photo-orientable group is rotated. Upon this rotation, that typically is 90°, the group adjacent to the second group R₂ is hence rotated, which means that the third group R₃ is forced to rotate together with the rotated second group R₂. This rotation of the third group R₃ conveys a change in the absorption cross section of said group. This gives therefore a contrast in absorption of incident light as compared to a non-rotated reference. This contrast in absorption subsequently leads to a difference in intensity of the emitted fluorescence.

The change of absorption cross section is also valid for the second group R₂ and in some cases, depending on the group, also for the first group R₁. The variation of molecular geometry and the induced local non-equilibrium states causes variations in the optical properties such as refractive index, double refraction or absorption properties, of which the latter will be described herein when a device for storing data and the storing principle thereof are further described below.

The order of the functional groups of FIG. 1 is shown for illustrative purposes only, and can hence be changed to cover a variety of orders all being within the scope of this invention.

In FIG. 4, a device 40 for storing data having stacked storage layers is illustrated in cross section in a direction perpendicular to a planar surface of the stacked layers. A base plate 41 is covered with a polymer layer 42. The base plate 41 is typically several cm² in surface area and may have an insulation layer such as an InO₂/SnO₂ layer deposited thereon, and/or optionally also have an alignment inducing layer deposited thereon. Such an alignment layer, such as a polyimide orientation layer or a photo-orientation layer consisting of cinnamate or coumarin derivatives, may require subsequent mechanical or photochemical interaction to induce the proper alignment. Furthermore, the polymer layer 42 can for instance be spin-coated or applied in another suitable way, and the thickness of the polymer layer can typically be from 10⁻³ to 10⁻⁶ m.

The polymer layer 42 is covered with a separation layer 43, optionally coated on the interface between 42 and 43 with an alignment layer as described above, whereby this combination, i.e. the polymer layer 42, the separation layer 43, optionally including said alignment layer can be stacked several times, in this particular embodiment illustrating three polymer layers. However, multiple polymer layers 42, typically more than ten can be provided. Alternatively, the polymer can be provided as laminate with other suitable materials, or as a coating on a matrix layer, even if these examples are not illustrated in this figure.

When writing into one polymer layer, a first laser beam from a light source (illustrated by an arrow labeled “light”) is focused on a certain area in the data storage medium, whereby the polymer in this area reorients due to the photo-orientable groups, which will be further disclosed below. The first laser beam, for instance having blue light, initiates the reorientation, whereby a second beam (from the same source) of an intensity high enough to heat the polymer above its glass-transition temperature T_{g}, completes the reorientation. The resulting written area can then be read as optical data.

The optical data storage device 40 can for instance be in the form of an optical disk, whereby data, typically in the form of bits, are read into circular tracks by means of a probing laser beam when this disk rotates in an optical record player or an optical card. Another possibility could be to provide holographic storage, whereby a hologram of an image is recorded as an interference pattern. These, and other applications will not be described in more detail, since such technologies are well known within this technical field. Now, FIG. 5a-c, are illustrating how the polymer is converted from a non-written condition to a written condition. The polymers, of which three are shown, are illustrated in a direction perpendicular to the cross-section in FIG. 4, i.e. in the same direction as the arrow denoted “light”. FIG. 5a shows a situation after alignment, but before initiation. FIG. 5b shows initiation of a central area 52 (the local focal area) of part of the polymer layer, herein the centre polymer, indicated by an arrow in the left corner thereof. FIG. 5c shows part of the polymer layer after being written. The central area 52 now comprises the groups in a direction, which is essentially perpendicular to the direction after alignment. This direction is only intended to illustrate the principle of the invention, and is therefore not limited to this particular direction.

In short, it is this reorientation of the aligned area 52 that enables en increased collection efficiency of emitted light, during the reading process, as will become more clear in the following paragraphs down below.

The initial orientation of the multi-functional polymers in FIG. 5a can be achieved for instance by means of surface effects such as shearing or drawing, by means of incorporated additives, such as surfactant molecules, or by means of an alignment inducing layer (as mentioned above) provided thereon, or by means of field effects such as an alignment field, particularly a magnetic field or an electrical field.

It is also possible to combine an alignment inducing layer and an alignment field. The alignment inducing layer could for instance force a homeotropic alignment of the functional groups in the polymer. The aligning force of the alignment inducing layer can be overruled by the force of an alignment field during deposition of the data layer. In this way a planar alignment is obtained. Now, during the writing process, the force exerted by the photo-orientable units and the force of the alignment inducing layer will co-operate to cause a reorientation of all functional groups. In this way, the writing speed can be enhanced. In the normal case where the alignment inducing layer causes planar alignment, the forces exerted by the alignment inducing layer and the photo-orientable units oppose each other during the writing process, limiting the writing speed.

The first laser beam that initiates the reorientation as illustrated in FIG. 5b moves on, while the initiated polymer material self-develops during a longer time period than the initiation takes to end up in its final orientation as illustrated in FIG. 5c. The time period that is required is determined by the type of polymer, the layer thickness, the local temperature, the anchoring energy of the polymer on the substrate optionally covered with an alignment inducing interlayer, all of which of course has to be properly chosen to fulfill the requirements regarding switching-time. A typical example can be something like a first laser beam within nanoseconds and a second heating beam for a few milliseconds, a particular example can be approximately 6 ns and 3 ms, respectively. This time period is determined by reorientation of the other groups than the photo-orientable group since the driving force for the other groups is relatively small (elastic energy), i.e. latter switch faster. It is also possible that heating and photo-reorientation is both done with a short laser pulse and that the material stays above T_{g} for several milliseconds as a result of the poor heat conductivity of the medium, allowing for the self-development. It is also possible that a short laser pulse is used to heat the sample above T_{g} (where it will stay for milliseconds (ms)) and a second irradiation over a longer time period is used for the photo-reorientation.

The laser beams can for instance originate from a diode laser, typically with a wavelength of approximately 400 nm. However, there is a great flexibility in the choice of wavelengths, both for writing and reading. For instance dyes can be added to provide sensitivity at a suitable wavelength. Both the writing beam and the heating beam can according to a preferred embodiment of the invention, be combined into one beam (as illustrated in FIG. 4) that both initiates and heats, or alternatively be spatially separated everywhere except at the desired writing position to increase non-linearity of the method.

The method for writing data according to a general preferred embodiment of the invention can be illustrated with a flow-chart as presented in FIG. 6. In a first step 61, the polymer material is heated to a temperature above the glass transition temperature T_{g}, in a second step 62, the heated material is aligned, and in a third step 63, writing is initiated by orientation of photo-orientable groups of the polymer by means of illuminating with light that initiates the reorientation.

Erasing the stored information can be obtained by increasing the temperature above the glass-transition temperature T_{g} and cooling in an electrical or magnetic field. It can also be obtained by re-alignment to the alignment layer when above the T_{g} or by a reversed photo-orientation process.

The glass-transition temperature T_{g} typically is above ambient temperature. However, it is preferred to have control over the glass transition temperature in order to be sure that the stored data will not be degraded during storage at desired temperatures. Such methods, for instance to use vinyl based polymers, are well known and will therefore not be further described herein. The time scale on which the laser pulse has to be applied is much shorter than the time-scale on which the anisotropic molecules reorient. Thereby, high recording data rates can be combined with a high recording stability.

If the groups are aligned by means of an electrical field, transparent electrodes can be provided surrounding the polymer layers from two sides. However, the electrodes do not have to be incorporated in the device. During manufacturing it is possible to apply an electric field even when the electrodes are not incorporated in the medium. For a WORM application, typically electrodes neither are required nor desired. For a (limited) RW application it is also possible to envision only two general electrodes that sandwich all storage layers to provide a general re-orientation capability for the whole device. If electrodes sandwich every layer, a more local erasure and initial material orientation per layer is possible. In principle, even a user-drive could be made to provide the external global alignment field so that an RW medium without internal electrodes is achieved. Because of the high voltages required in this case (the voltages increase linearly with the separation of the electrodes), this might not be the most practical solution, even if it is possible.

Reading of information can be performed by, by for instance, irradiating the polymer layer or layers with monochromatic coherent light. Typically laser light is used to read data by means of using the change in orientation of anisotropic fluorescent chromophores comprised in the third group R₃. These fluorescent chromophores can be constituted of any fluorescent organic or inorganic molecules with a dipole moment, preferably selected from the group of: liquid crystal systems, organic dyes, nanotubes, nanowires and polymers with substitutents containing any molecules selected from the above mentioned group. Also other groups than those mentioned may however be used, instead or in combination.

The different orientation of the transition dipole moments of the fluorescent chromophores in “written” and “non-written” areas causes a contrast in absorption and thus in fluorescence. The contrast can typically be about 1:7. Of course, also other anisotropic groups that change orientation can be employed, for instance the photo-orientable group. Also other types of groups than anisotropic, which change optical properties when illuminated with light from an intense writing beam, and which properties can be read by a reading beam, having an intensity lower than that of the writing beam, may be possible, provided that the initiation is fast enough. It is also possible to provide the optical properties in a blend, rather than in the polymer itself, or to use additives.

In addition, the third group R₃ comprising the anisotropic fluorescent chromophores are typically aligned as explained above. With reference to FIG. 7, it is clearly shown the dependency of the numeric aperture on the collection efficiency of emitted light. Due to the limited numerical aperture (NA) only a part of the emitted light is in practice collected. For isotropic orientation (S=0) of chromophores only 4% of the emitted light is collected (NA=0.6). However, by alignment of anisotropic fluorescent chromophores, an anisotropic emission of fluorescence can be achieved. For perfectly aligned chromophores the collection efficiency ≈3(NA/2n)², where NA and n are as described above. In this case the order parameter, S=1. However, for a realistic alignment of these anisotropic chromophores, the order parameter S, that also depends on the type of induced liquid crystalline phase by group R₁, equals 0.5-0.9, typically around 0.65. The collection efficiency of the emitted fluorescent light is hereby increased by a factor of 2, as compared to that of isotropically oriented anisotropic chromophores, for which S=0. This effect of anisotropic dipole emission is therefore very useful and is hence enabled by the inventive idea of this invention.

The inventive concept of this invention titled optimized medium with anisotropic dipole emission for fluorescent single or multi layer storage, has several advantageous over prior art.

These advantages are the following: increased fluorescent signal intensity through anisotropic emission (realistically a factor two in photons), increased absorption cross section (enabling thinner layers for a given, optimal absorption), increased stability of stored information, fast writing speed made possible, and independent optimization of material properties made possible.

Since also the invention provides a small difference in the index of refraction of written and non-written bits, this will result in reduction of beam quality as the light transverses the different layers, even if it is small compared to conventional techniques. In a stacked device having many polymer layers, say above ten, the differences between written and non-written bits can be further reduced by careful choice of materials, i.e. typically by selecting a fourth compensating group. Alternatively, this difference could instead be increased to be used by sensing this as an optical parameter, for instance by means of a differential phase contrast microscope set-up in transmission.

Even if only reading by means of using fluorescence is described in the examples, any other method capable of sensing optical parameters dependent on molecular orientation can be employed.

The device for optical data storage can also be used e.g. for optical signal processing, Fourier transform, and other recording purposes than described.

As used in the following claims, the word “comprise” means including, but not necessarily limited to.

1. A method for writing data in a storage medium (42,43) comprising polymer material (10,42) by modifying its optical properties, said method comprising the steps of:
heating up the material above the glass-transition temperature (T_{g}),
performing alignment of said material,
initiating the writing by reorientation of photo-orientable-groups (R) in the polymer material (10,42) by means of illuminating with light at a wavelength and for a time period, or other means, that initiates the reorientation, and that enables anisotropic emission from the storage medium (42,43) during a reading process.

2. A method according to claim 1, in which the material includes dipole emitters and the alignment enables anisotropic emission from the aligned anisotropic dipole emitters of the storage medium.

3. A method according to claim 2, in which the dipole emitters are fluorescent and the alignment enables anisotropic emission of fluorescent dipole emitters.

4. A method according to claim 1, wherein the reorientation of photo-orientable groups, comprises reorientation of one or more anistropic groups present in the polymer material.

5. A method according to claim 1, wherein initiating and heating are performed by means of a single beam.

6. A method according to claim 1, wherein initiating is performed by means of a first beam and heating is achieved with a second beam.

7. A method according to claim 1, wherein initiating is performed during a time period which is much shorter than a time scale on which the polymer, preferably an LC polymer, reorients, typically a time period within a nanosecond time regime such as 10-50 ns.

8. Device (40) for optical data storage, comprising:
polymer material (10,42) as storage medium,
means for heating up the material above the glass-transition temperature (T_{g}),
means for performing alignment of the material, and
means for initiating the writing by reorientation of photo-orientable units of the polymer (10,42) by illuminating with light at a wavelength and for a time period, or other means, that initiates the reorientation, whereby data can be stored in the polymer material by modifying its optical properties, enabling anisotropic emission from the device during a reading process.

9. Device according to claims 8, wherein the polymer material further comprises dipole emitters that can be aligned, for enabling anisotropic dipole emission from the device during a reading process.

10. Device according to claim 9, wherein the dipole emitters comprise anisotropic fluorescent chromophores, for enabling anisotropic emission of fluorescence from the device during a reading process.

11. Device according to claim 10, wherein the fluorescent chromophores constitute any fluorescent organic or inorganic molecules with a dipole moment, selected from the group of: liquid crystal systems, organic dyes, nanotubes, nanowires and polymers with substitutents containing any molecules selected from the above mentioned group.

12. Device according to claim 8, wherein the polymer material comprises one or more anisotropic polymers.

13. Device according to claim 8, wherein a polymer layer, preferably a polymer film, is provided on a transparent base plate.

14. Device according to claim 8, wherein said device comprises combined heat source means and light source means, whereby said polymer film may be heated and the molecular order or orientation of said film may be varied.

15. Device according to claim 8, wherein said device comprises physical orientation means such as an alignment layer, and/or transparent electrode means for orientation of the polymer layers.

16. Device according to claim 8, wherein said heating source means and/or light source means comprises a laser.

17. Device according to claim 8, wherein absorption properties of said polymer film provide data to be stored with a laser beam of a particular wavelength and intensity and read out with another laser beam having a different wavelength, or different intensity significantly below the writing threshold, not disturbing the stored data.

18. Storage medium (42,43) comprising polymer material (10,42), adapted to store data by modifying its optical properties, said polymer material comprising photo-orientable groups (R), that can be reoriented, subsequent to being aligned, upon illumination with light at a wavelength and for a time period that initiates the reorientation, where the photo-orientable groups can self-develop at a suitable temperature, typically above the glass transition temperature (T_{g}), said polymer material comprising anisotropic fluorescent emitters, enabling an anisotropic emission of fluorescence during reading said stored data.

19. Storage medium according to claim 18, comprising groups selected from: azobenzene, biazobenzene, triazobenzene and azoxybenzene, as well as alkyl substituted derivatives of the said compounds, stilbene or spiropyran group.

20. Storage medium according to claim 18, wherein the polymer material comprises a singular polymer layer.

21. Storage medium according to claim 18, wherein the polymer material comprises a multiple of polymer layers.

22. A method of reading data stored in a device according to claim 9, said method comprising the steps of:
illuminating with light at a wavelength, that causes the anisotropic fluorescent dipole emitters to emit light and,
collecting the anisotropic emission from said dipole emitters.
